(19) United States
(12) Patent Application Publication
(10) Pub. No.: US 2018/0290311 A1
(43) Pub. Date: Oct. 11, 2018

(54) ROBOTIC ARM WITH A TOOL INTERFACE COMPRISING AN ELECTRONICALLY CONTROLLABLE TOOL ATTACHMENT

(71) Applicants: Suryansh CHANDRA, London (GB); Mostafa ELSAYED, London (GB)

(72) Inventors: Suryansh CHANDRA, London (GB); Mostafa ELSAYED, London (GB)

(21) Appl. No.: 15/766,833

(22) PCT Filed: Oct. 7, 2016
(86) PCT No.: PCT/GB2016/053140

§ 371 Date: Apr. 9, 2018

(30) Foreign Application Priority Data
Oct. 9, 2015 (GB) 1517930.2

(51) Int. Cl. B25J 15/04; B25J 9/16; B25J 9/04

(52) U.S. Cl. CPC B25J 15/0441; B25J 15/0466; B25J 15/0483; B25J 9/161; B25J 9/1679; B25J 9/1694; B25J 9/046; B25J 9/1612

(57) ABSTRACT

The present invention relates to a robotic arm with a tool interface (16) comprising an electronically controllable tool attachment for affixing a tool to the interface.

### FIELD

The present invention relates to robot arms. In particular, this invention relates to robot arms for industrial use that have hot-swappable attachments. This invention also relates to a method of allowing a robot arm to exchange the hot-swappable attachments when needed without manual assistance or intervention.

### BACKGROUND

Industrial robots are automatically controlled, reprogrammable, multipurpose manipulators that are typically programmable in three or more axes. Typical applications can include moving objects, welding, painting, and product assembly and testing. Robots are advantageous where such applications require high endurance, precision or speed in comparison to the abilities of a human workforce.

Many industrial robots fall into the category of robot arms. Robot arms can be programmed to perform repetitive actions (without the variation that can occur when the same task is performed by a human). More advanced implementations of robot arms may involve the robot arm needing to assess tasks that it is programmed to perform, for example using forms of machine vision to determine the orientation of objects to be moved.

In a typical robotic arm, a number of segments are joined by joints to enable movement of the robotic arm. A computer controls the robotic arm by actuating a number of motors in the robotic arm such that the robotic arm performs a sequence of motions in order to complete a specific task.

An end-effector is provided at the end of the robot arm depending on the function of the robot arm, for example a gripper would be provided on robot arms that move objects. The end-effector is selected for the robot arm when it is being integrated into the industrial environment in which it operates, and configured when the robot arm is programmed for its desired task.

### SUMMARY OF INVENTION

Aspects and/or embodiments can provide a method and/or system for providing alternative effectors for a robot arm that can enable switching between different functions with improved efficiency.

According to one aspect, there is provided a robotic arm with a tool interface comprising an electronically controllable tool attachment for affixing a tool to the interface.

Providing a mechanism that can exchange attachments for a robot arm without human intervention can provide for a robot arm to be programmed more flexibly, allowing it to adapt its function by exchanging effectors.

Optionally, the tool interface is an integral component of the robotic arm. This can enable a robust interface. The tool interface may be provided with resources via conduits integral to the robotic arm. The tool interface may be provided with resources substantially via conduits integral to the robotic arm. The tool interface may be provided with one or more of: power; hydraulic or pneumatic pressure; and/or data resources substantially via conduits integral to the robotic arm. This can reduce the risk of conduits to the interface interfering with movement of the robotic arm and becoming damaged.

Optionally, the electronically controllable tool attachment is an electromagnetic attachment.

Providing an electromagnetic attachment allows for the electromagnet to be disactivated, allowing any tool attachment to be disengaged and other tool attachments to be engaged when the electromagnet is re-activated. Further, an electromagnet can be controlled by the robot arm through its programming, allowing further flexibility of function and programming.

Optionally, the electronically controllable tool attachment is an interlocking attachment.

Providing an interlocking attachment can allow for tool attachments to be more securely engaged to the robot arm.

Optionally, the tool interface further comprises a data port for data communication with a tool.

Providing a data port allows for data to be sent and received between the tool attachment and the robot arm controller, providing for further functionality in the tool attachment, for example allowing it to provide sensor(s) in the tool attachment that can feedback information to the robot arm controller and/or programming.

Optionally, the tool interface further comprises a power port for providing power to a tool.

Providing power to the tool attachment allows for further functionality in the tool attachment, for example allowing it to provide sensor(s) in the tool attachment that can feedback information to the robot arm controller and/or programming or mechanical manipulators.

Optionally, the tool interface further comprises a pneumatic port for providing pressure to a tool.

Providing pneumatic pressure to the tool attachment allows for further functionality in the tool attachment, for example allowing it to manipulate mechanical effectors such as grips or spray paint mechanisms.

Optionally, the tool interface is rotationally symmetrical to enable attachment of a tool in a variety of angular orientations about a connection axis.

Providing a rotationally symmetrical interface allows the tool attachment to be attached regardless of the relative orientations of the tool attachment and the end of the robot arm.

Optionally, the tool interface is circular to enable attachment of a tool in an arbitrary angular orientation about a connection axis.

Providing a circular interface allows the tool attachment to be attached regardless of the relative orientations of the tool attachment and the end of the robot arm.

According to another aspect there is provided a tool for use with a robotic arm according to any preceding claim that is affixable to the tool interface.

Providing a tool that can be exchanged as an attachment for a robot arm without human intervention can provide for a robot arm to be programmed more flexibly, allowing it to adapt its function by exchanging effectors.

Optionally, the tool comprises at least one of: a mechanical gripper; a pneumatic gripper; a screw head attachment; and a machine specific attachment.

Providing a variety of effector functions can provide for a robot arm to be programmed more flexibly, allowing it to adapt its function by exchanging effectors.

Optionally, the tool comprises an identifier for the robotic arm to identify the tool.

Providing a way to identify a variety of effector functions can provide for a robot arm to be programmed more flexibly, allowing it to adapt its function by exchanging effectors by locating the desired or programmed effector using an identifier.

Optionally, the tool comprises a sensor to identify an orientation of the tool.

According to another aspect there is provided software for controlling a robotic arm with a tool affixed to the robotic arm, wherein the software is adapted to receive an identification of the tool.

Software that can identify the effector installed on a robot arm can provide a way for a robot arm to be programmed more flexibly, allowing it to adapt or verify its function depending on an installed effector.

Optionally, the software is adapted to receive an orientation of the tool.

Software that can identify the orientation of an installed effector on a robot arm can provide a way for a robot arm to be programmed more flexibly, allowing it to adapt or verify its function depending on an installed effector.

Optionally, the software is adapted to provide feedback (preferably visual feedback) when a tool is engaged or disengaged. This can enable confirmation to the user regarding attachment or detachment of a new tool.

Optionally the software is adapted to provide visual feedback in the form of rendering of a representation of the tool in the appropriate position and engagement with the robotic arm. The rendering may include a representative form or geometry of the tool. This can enable intuitive understanding of the tool positioning for the user.

According to another aspect there is provided a method of controlling a robotic arm as aforementioned with a tool as aforementioned affixed to the robotic arm.

According to another aspect there is provided a computer programme product comprising software code for carrying out a method as aforementioned.

According to another aspect there is provided a tool interface for a robotic arm comprising an electronically controllable tool attachment for affixing a tool to the interface. Optionally the tool interface is as aforementioned.

According to another aspect there is provided a kit of parts comprising a robotic arm as aforementioned and a tool as aforementioned.

Aspects and/or embodiments can also extend to a robotic arm substantially as herein described and/or with reference to the accompanying figures.

Aspects and/or embodiments can also extend to methods and/or apparatus substantially as herein described with reference to the accompanying drawings.

Aspects and/or embodiments can also provide a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

Aspects and/or embodiments can also provide a signal embodying a computer program for carrying out any of the methods described herein and/or for embodying any of the apparatus features described herein, a method of transmitting such a signal, and a computer product having an operating system which supports a computer program for carrying out any of the methods described herein and/or for embodying any of the apparatus features described herein.

Any apparatus feature as described herein may also be provided as a method feature, and vice versa. As used herein, means plus function features may be expressed alternatively in terms of their corresponding structure, such as a suitably programmed processor and associated memory.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

Furthermore, features implemented in hardware may generally be implemented in software, and vice versa. Any reference to software and hardware features herein should be construed accordingly.

### BRIEF DESCRIPTION OF THE DRAWINGS

These and other aspects of the present invention will become apparent from the following exemplary embodiments that are described with reference to the following figures in which:

FIG. 1 is a perspective view of a robotic arm;

FIG. 2 is a side view of the robotic arm of FIG. 1 in different configurations;

FIG. 3 is a plan view of the robotic arm of FIG. 1 in different configurations;

FIG. 4 is an exploded perspective view of the robotic arm of FIG. 1; and

FIG. 5 is a perspective view of a portion of the robotic arm of FIG. 1.

### SPECIFIC DESCRIPTION

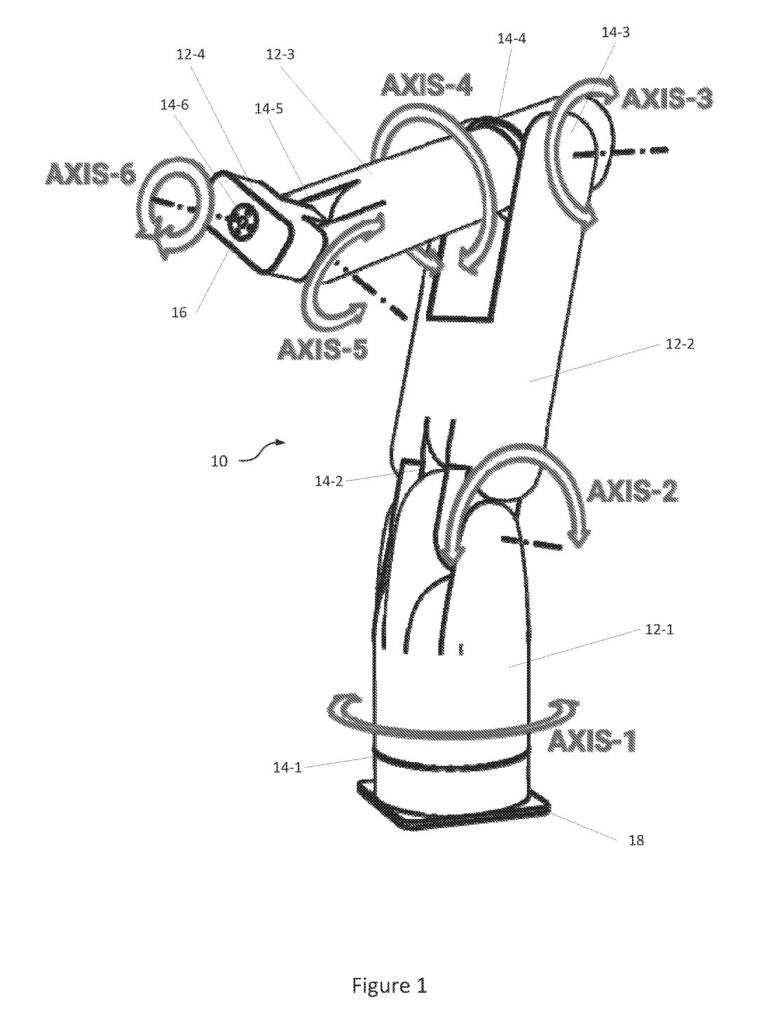

FIG. 1 shows a robotic arm 10 with six degrees of freedom. The robotic arm 10 is composed of four segments 12 attached to one another by three joints 14. Two of the segments 12-1 12-3 can rotate axially in addition to being rotatable about the joints 14. The last segment 12-4 (also referred to as the tool segment) has a tool interface 16 for fixing a tool to the robotic arm. The tool can be rotated in the segment axis. The first segment 12-1 (also referred to as the base segment) has a base portion 18 for fixing the robotic arm to a surface. The six degrees of freedom are indicated in FIG. 1 with arrows. With six degrees of freedom the robotic arm 10 can trace any desired trajectory with the tool interface 16 within the reach of the robotic arm 10. Additionally, a tool fixed to the robot arm can be guided to a destination with any desired orientation and the tool can be moved in space with six degrees of freedom (e.g. translation in 3 orthogonal directions and rotation around three orthogonal axes).

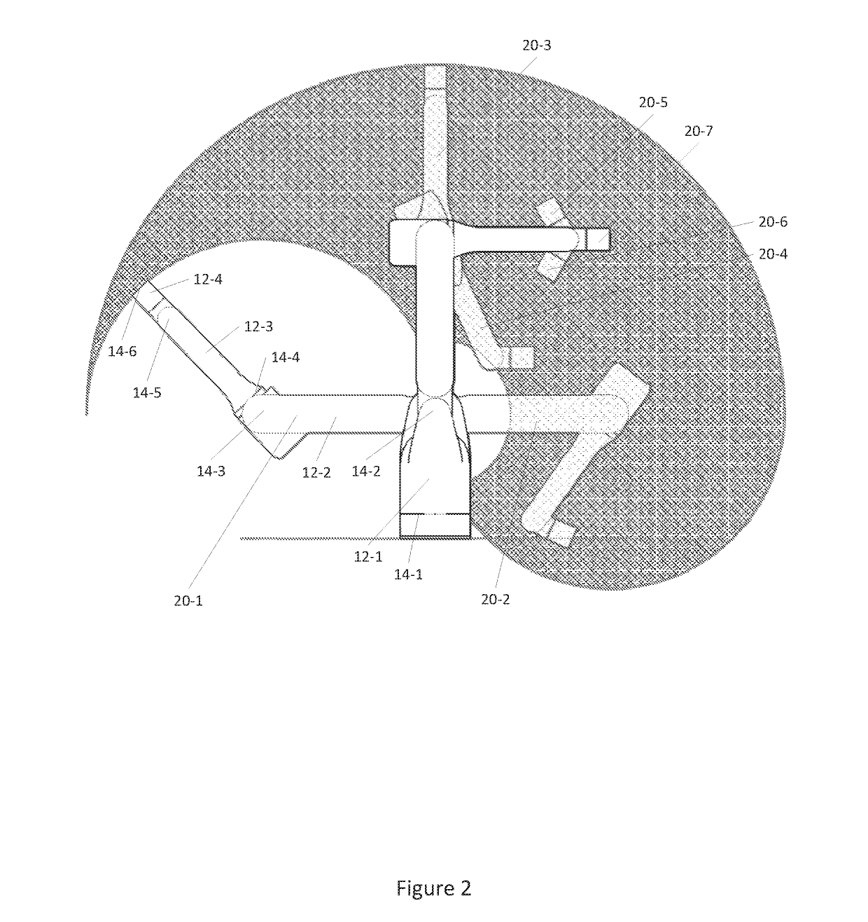

FIG. 2 shows a side view of the robotic arm 10 in seven different configurations 20 within a plane. Grey shading indicates the area that the robotic arm 10 can access within the maximum reach of the arm within that plane through rotation of the second joint 14-2, third joint 14-3 and fifth joint 14-5 alone. Two configurations 20-1 20-2 show the second segment 12-2 at either extreme that the second joint 14-2 permits, at 90° from vertical in either direction. Two configurations 20-3 20-4 show the third segment 12-3 at either extreme that the third joint 14-3 permits, in extension of the second segment 12-2 and at 155° from that extension. Two configurations 20-5 20-6 show the fourth segment 12-4 at either extreme that the fifth joint 14-5 permits, at 120° from the extension of the third segment 12-3 in either direction. One configuration 20-7 shows the fourth segment 12-4 in the extension of the third segment 12-3. The remaining first joint 14-1, fourth joint 14-4 and sixth joint 14-6 permit 360° of rotation about a segment axis: the first joint 14-1 in the axis of the first segment 12-1, the fourth joint 14-4 in the axis of the third segment 12-3 and the sixth joint 14-6 in the axis of the fourth segment 12-4.

One of the configurations 20-3 shows the arm 10 in maximum vertical extension. In this configuration 20-3 the reach is 600 mm from the axis of the first joint 14-1. The reach in this configuration 20-3 with the first segment included is 810 mm. The maximum horizontal reach is 600 mm from the axis of the first joint 14-1 in either direction. The maximum reach of the third and fourth segments 12-3 12-4 together (when in extension of one another) is 300 mm. In a variant a gantry, a mobile platform or a UAV (typically a stable flying platform such as a quadrocopter would be more suited to this augmentation) may be provided to extend the maximum reach of the robot arm.

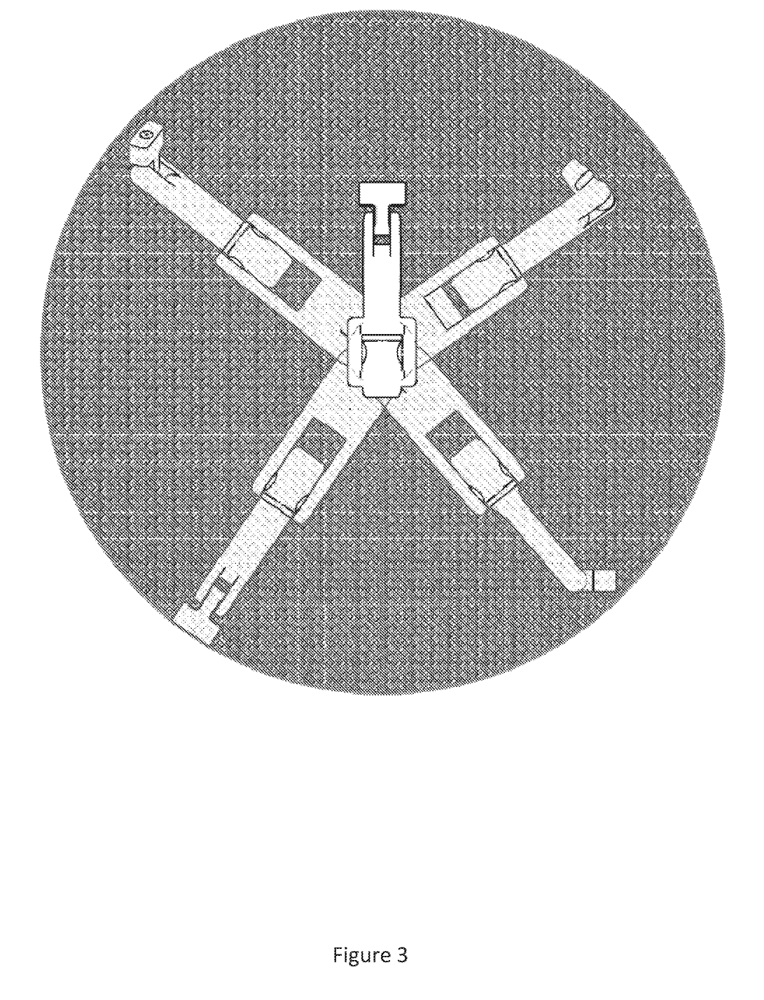

FIG. 3 shows a plan view of the robotic arm 10 in 5 different configurations 20 within a plane. Grey shading indicates the area that the robotic arm 10 can access within the maximum reach of the arm within that plane. The footprint of the arm is 120 mm by 120 mm. The base segment 12-1 can rotate 360° around a vertical axis.

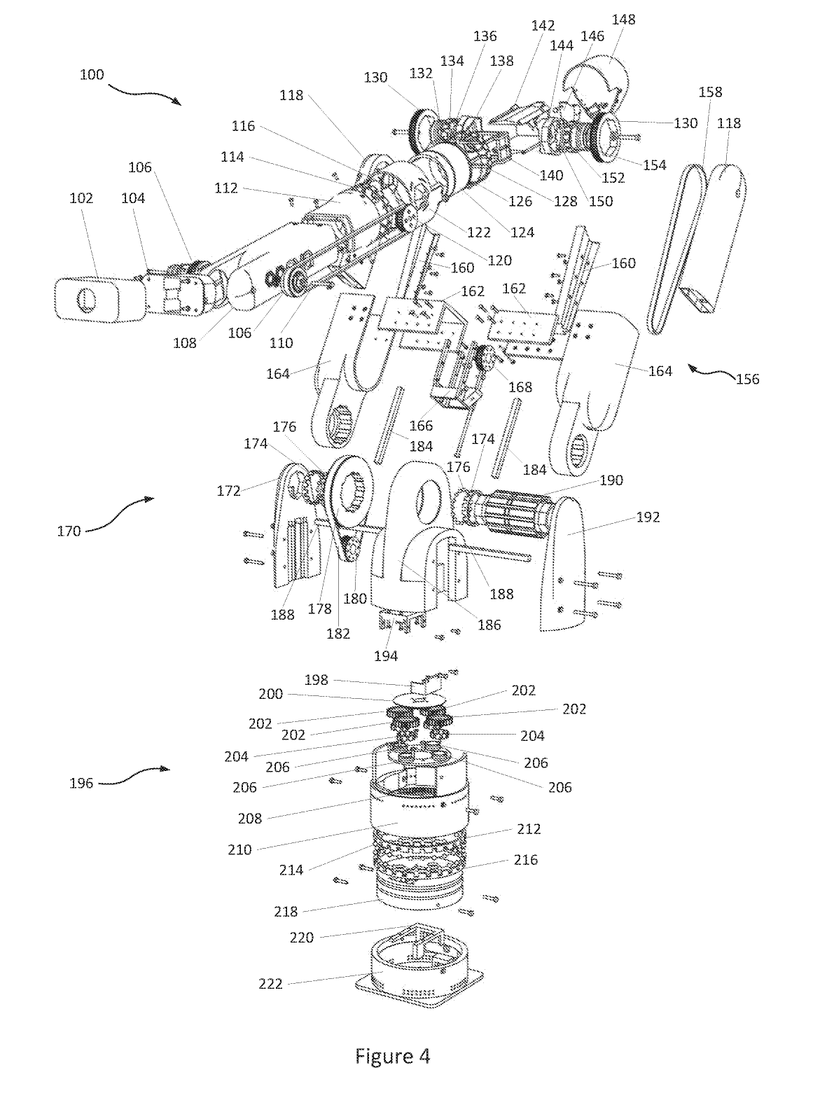

FIG. 4 shows an exploded perspective view of a robotic arm 100. The parts in FIG. 4 are:

100 Forearm

102 Wrist cover

104 Wrist attachment flange

106 Wrist articulation unit

108 Lower forearm shell/wrist attachment bracket

110 Wrist drive belt

112 Upper forearm shell

114 Lower forearm bearing cage

116 Lower forearm ball bearings

118 Elbow outer mounting bracket

120 Wrist driver pulley

122 Outer forearm shell with internal bearing raceway

124 Inner forearm shell (goes inside the outer shell and contains motor to drive forearm gear), with internal bearing raceway

126 Upper-forearm ball bearings

128 Upper-forearm bearing cage

130 Elbow pulley

132 Right elbow inner mounting bracket with internal bearing raceway

134 Right elbow bearing cage

136 Right elbow ball bearings

138 Right elbow gear attachment point with internal bearing raceway

140 Wrist motor mounting bracket

142 Wrist motor retainer

144 Left elbow gear insert

146 Wrist-twist motor mount

148 Elbow cap

150 Left elbow ball bearings

152 Left elbow bearing cage

154 Left elbow inner mounting bracket

156 Arm

158 Elbow drive belt

160 Shoulder stiffening flange

162 Shoulder attachment bracket

164 Upper arm shell

166 Elbow motor bracket

168 Elbow driver pulley

170 Shoulder

172 Right shoulder shell

174 Shoulder bearing cage

176 Shoulder ball bearings

178 Shoulder internal gear

180 Shoulder drive gear

182 Shoulder drive belt

184 Square cross section structural stiffeners

186 Shoulder joint mounting

188 Reinforcing rod for motor mount

190 Shoulder joint axle with internal bearing raceways

192 Left shoulder shell

194 Shoulder motor bracket (motor drives gear 180)

196 Waist

198 Shoulder motor lower mount

200 Combined cage retainer

202 Waist planetary gears with integrated bearing raceway

204 Waist planetary gear bearing cage and balls

206 Waist planetary gear retainer with integrated bearing raceway

208 Waist integrated planetary gear

210 Waist shell with integrated bearing raceway

212 Waist upper bearing cage

214 Waist ball bearings

216 Waist lower bearing cage

218 Waist motor mount with integrated bearing raceway

220 Waist motor bracket

222 Base unit with integrated microprocessor, microcontroller, switched-mode power supply

Within the robotic arm 6 motors are included to move the robotic arm as desired. The 6 motors are mounted at the wrist cover 102, the wrist motor mounting bracket 140, the wrist-twist motor mount 146, the elbow motor bracket 166, the shoulder motor bracket 194 and the waist motor bracket 220. The motors are of metal and the belts are of rubber, but all other parts are of plastics. Examples of plastics are nylon (or other polyamides PA), acrylonitrile butadiene styrene, poly lactid acid, copolymer acetal (POM-C), homopolymer acetal (POM-H), polybutylene terephthalate (PBT), liquid crystal polymer (LCP), thermoplastic elastomer (TPC-ET) and polyphthalamide (PPA). Typical material performances of some representative plastics are:

### Nylon 66 HI (ST801) Such as Premier Plastic Resin Product Number PPR-6605HI

Tensile strength: 6800 psi/46.9 Mpa (ASTM test method D-638)
Elongation at break: 180% (ASTM test method D-638)
Flexural modulus: 245000 psi/1690 Mpa (ASTM test method D-790)
Flexural strength: 9500 psi/66 Mpa (ASTM test method D-790)
Izod impact: 18 ft-lb/in/960 J/m (ASTM test method D-256)
Melting point: 491° F./255° C. (ASTM test method D-3418)
Specific gravity: 1.08 (ASTM test method D-792)
Heat deflection temperature at 264 psi: 160° F./71° C. (ASTM test method D-648)

### ABS Low Gloss Natural Such as Premier Plastic Resin Product Number PPR-ABS04

Tensile strength: 6000 psi/41.4 Mpa (ASTM test method D-638)
Elongation at break: 35% (ASTM test method D-638)
Flexural modulus (tangent): 310000 psi/2140 Mpa (ASTM test method D-790)
Flexural strength: 10500 psi/72.4 Mpa (ASTM test method D-790)
Izod impact (notched): 2.7 ft-lb/in/140 J/m (ASTM test method D-256)
Specific gravity: 1.06 (ASTM test method D-792)
Melt flow rate (230° C./3800 g): 5 g/10 minutes (ASTM test method D-1238)
Heat deflection temperature at 264 psi: 185° F./85° C. (ASTM test method D-648)
Heat deflection temperature at 66 psi: 195° F./91° C. (ASTM test method D-648)
Linear mould shrinkage: 0.006 (ASTM test method D-955)

### Poly Lactic Acid Such as FKuR Kunstoff GmbH Product Number Bio-Flex® V 135001 (Trial Grade)

Modulus of elasticity: 2960 Mpa (ISO test method 527)
Tensile strength: 61.5 MPa (ISO test method 527)
Tensile strain at tensile strength: 5.3% (ISO test method 527)
Tensile stress at break: 38 MPa (ISO test method 527)
Tensile strain at break: 10.5% (ISO test method 527)
Flexural modulus: 3295 MPa (ISO test method 178)
Flexural strain at break: no break (ISO test method 178)
Flexural stress at 3.5% strain: 88.8 MPa (ISO test method 178)
Notched impact strength (Charpy), room temperature: 2.8 kJ/m² (ISO test method 179-1/1 eA)
Impact Strength (Charpy), room temperature: 30.8 kJ/m² (ISO test method 179-1/1 eA)
Density: 1.24 g/cm³ (ISO test method 1183)
Melting temperature: >155° C. (ISO test method 3146-C)
Melt flow rate (190° C./2.16 kg): 3-5 g/10 minutes (ISO test method 1133)

### DuPont Performance Polymers Delrin® 988PA NC010 Acetal (POM)

Tensile Strength, Yield: 72.0 MPa (ISO 527-1/-2)
Elongation at Yield: 12% (ISO 527-1/-2)
Tensile Modulus: 3.20 GPa (ISO 527-1/-2)
Flexural Modulus: 3.00 GPa (ISO 178)
Density: 1.42 g/cc (ISO 1183)
Melt Flow: 21 g/10 min at load 2.16 kg, temperature 190° C. (cm³/10 min; ISO 1133)
Melting Point: 178° C. (10° C./min; ISO 11357-1/-3)
Flammability, UL94: HB at thickness 0.800 mm (IEC 60695-11-10)

### Celanese Zenite® 7130 WT010 LCP

Specific Gravity: 1.65 g/cc (ASTM D 792)
Density: 1.67 g/cc (ISO 1183)
Filler Content: 30%
Linear Mold Shrinkage, Flow: −0.00100 cm/cm at thickness 15.7 mm; 0.00 cm/cm at thickness 3.17 mm (ASTM D955)
Linear Mold Shrinkage, Transverse: 0.0080 cm/cm at thickness 3.17 mm; 0.0090 cm/cm at thickness 1.60 mm (ASTM D955)
Hardness, Rockwell M: 63 (ASTM D 785)
Hardness, Rockwell R: 110 (ASTM D 785)
Tensile Strength at Break: 150 MPa (ISO 527)
Elongation at Break: 1.4% (ISO 527)
Tensile Modulus: 16.5 GPa (ISO 527)
Flexural Strength 210 MPa at temperature 23.0° C. (ISO 178)
Flexural Modulus: 13.0 GPa at temperature 23.0° C. (ISO 178)
Compressive Strength: 89.0 MPa (ASTM D 695)
Shear Strength: 57.0 MPa at thickness 0.800 mm; 58.0 MPa at thickness 3.17 mm (ASTM D732)
Izod Impact, Notched: 18.0 kJ/m² at temperature 23.0° C. (ISO 180/1A)
Izod Impact, Unnotched: 30.0 kJ/m² at temperature 23.0° C. (ISO 180/1U)
Charpy Impact, Unnotched: 3.00 J/cm² at temperature 23.0° C. (ISO 179/1eU)
Charpy Impact, Notched: 2.00 J/cm² at temperature 23.0° C. (ISO 179/1eA)
Volume Resistivity: 1.00e+16 ohm-cm (ASTM D 257)
Surface Resistance: 1.00e+15 ohm (ASTM D 257)
Dielectric Constant 3.5 at frequency 1.00e+6 Hz, temperature 23.0° C. 0.8 mm (ASTM D 150)
Melting Point: 352° C. (10° C./min; ISO 11357-1/-3)
Deflection Temperature at 1.8 MPa: 310° C. (ISO 75-1/-2 1993/N2)
Glass Transition Temp, Tg: 120° C. (ASTM D 3418)

### DuPont Performance Polymers Hytrel® 6356 TPC-ET

Density: 1.22 g/cc (ISO 1183)
Melt Density: 1.06 g/cc at temperature 230° C.
Water Absorption: 0.50% at time 24 hour (ASTM D 570); 0.60% at thickness 2.00 mm (similar to ISO 62)
Moisture Absorption: 0.200% at Thickness 2.00 mm (similar to ISO 62)
Linear Mold Shrinkage, Flow: 0.015 cm/cm (ISO 294-4, 2577)
Linear Mold Shrinkage, Transverse: 0.015 cm/cm (ISO 294-4, 2577)
Melt Flow: 9.0 g/10 min at load 2.16 kg, temperature 230° C. (ISO 1133)
Hardness, Shore D: <=63; 57 at time 15.0 sec (ISO 868)
Tensile Strength at Break: 43.0 MPa (ISO 527-1/-2)
Tensile Stress: 12.0 MPa at Strain 5.00%; 18.8 MPa at Strain 50.0%; 19.0 MPa at Strain 100% (ISO 527-1/-2)
Tensile Strength, Yield: 19.0 MPa (ISO 527-1/-2)
Elongation at Break: >=300%; 500% Nominal (ISO 527-1/-2)
Elongation at Yield: 33% (ISO 527-1/-2)
Tensile Modulus: 0.280 GPa (ISO 527-1/-2)
Flexural Modulus: 0.290 GPa (ISO 178)
Izod Impact, Notched: 81.0 kJ/m² at Temperature 23.0° C. (ISO 180/1A)
Charpy Impact, Notched: 12.0 J/cm² at Temperature 23.0° C. (ISO 179/1eA)
Impact: 300 at Temperature 23.0° C. (kJ/m² Tensile notched impact strength; ISO 8256/1)
Tensile Creep Modulus, 1 hour: 248 MPa (ISO 899-1)
Tensile Creep Modulus, 1000 hours: 182 MPa (ISO 899-1)
Tear Strength: 145 kN/m normal; 158 kN/m parallel (ISO 34-1)
Abrasion: 110 mm³ (ISO 4649)
Volume Resistivity: 8.00e+13 ohm-cm (IEC 60093)
Surface Resistance: >=1.00e+15 ohm (IEC 60093)
Dielectric Constant: 4.1 at Frequency 1.00e+6 Hz; 4.6 at Frequency 100 Hz (IEC 60250)
Dielectric Strength: 20.0 kV/mm (IEC 60243-1)
Dissipation Factor: 0.012 at Frequency 100 Hz (IEC 60250)
CTE, linear, Parallel to Flow: 178 μm/m-° C. (ISO 11359-1/-2)
CTE, linear, Transverse to Flow: 176 μm/m-° C. (ISO 11359-1/-2)
Specific Heat Capacity: 2.15 J/g-° C. (melt)
Thermal Conductivity: 0.150 W/m-K (Melt)
Melting Point: 210° C. (10° C./min; ISO 11357-1/-3)
Deflection Temperature at 0.46 MPa: 80.0° C. (ISO 75-1/-2)
Deflection Temperature at 1.8 MPa: 45.0° C. (ISO 75-1/-2)
Brittleness Temperature: −96.0° C. (ISO 974)
Glass Transition Temp, Tg: 0.000° C. (10° C./min; ISO 11357-1/-2)
   Polyphthalamide (PPA), 50% Glass Fiber Reinforced (Typical Values for Products from Different Providers)

| | Metric | Comments |
|---|---|---|
| Physical Properties | | |
| Density | 1.55-1.99 g/cc | Average value: 1.64 g/cc Grade |
| | | Count: 60 |
| Filler Content | 45.0-50.0% | Average value: 47.8% Grade |
| | | Count: 39 |
| Water Absorption | 0.0200-3.60% | Average value: 0.567% Grade |
| | | Count: 18 |
| | 0.850-0.950% | Average value: 0.917% Grade |
| | @Temperature 70.0-70.0° C. | Count: 6 |
| Moisture Absorption at | 1.00-1.20% | Average value: 1.13% Grade |
| Equilibrium | | Count: 3 |
| Linear Mold Shrinkage | 0.000100-0.00600 cm/cm | Average value: 0.00249 cm/cm |
| | | Grade Count: 51 |
| Linear Mold Shrinkage, | 0.00100-0.0100 cm/cm | Average value: 0.00566 cm/cm |
| Transverse | | Grade Count: 33 |
| Mechanical Properties | | |
| Hardness, Rockwell R | 124-126 | Average value: 125 Grade |
| | | Count: 10 |
| Ball Indentation Hardness | 340-360 MPa | Average value: 353 MPa Grade |
| | | Count: 3 |
| Tensile Strength, Ultimate | 13.9-290 MPa | Average value: 199 MPa Grade |
| | | Count: 53 |
| | 60.0-225 MPa | Average value: 107 MPa Grade |
| | @Temperature 60.0-230° C. | Count: 5 |
| | 107-145 MPa | Average value: 107 MPa Grade |
| | @Temperature 130-180° C. | Count: 5 |
| | 107-145 MPa | Average value: 107 MPa Grade |
| | @Time 3.60e+6-7.20e+7 sec | Count: 5 |
| | 8.38-321.27 MPa | Average value: 107 MPa Grade |
| | @Strain 0.100-4.30% | Count: 3 |
| | 8.38-321.27 MPa | Average value: 107 MPa Grade |
| | @Temperature −40.0-150° C. | Count: 3 |
| Tensile Strength, Yield | 24.8-260 MPa | Average value: 211 MPa Grade |
| | | Count: 7 |
| Elongation at Break | 0.600-3.10% | Average value: 2.10% Grade |
| | | Count: 58 |
| | 2.00-7.20% | Average value: 4.29% Grade |
| | @Temperature 60.0-230° C. | Count: 5 |
| Modulus of Elasticity | 11.0-22.1 GPa | Average value: 17.1 GPa Grade |
| | | Count: 56 |
| | 1.10-17.0 GPa | Average value: 10.4 GPa Grade |
| | @Temperature 60.0-175° C. | Count: 5 |
| | 10.3-10.3 GPa | Average value: 10.4 GPa Grade |
| | @Temperature 135-135° C. | Count: 1 |
| | 10.3-10.3 GPa | Average value: 10.4 GPa Grade |
| | @Time 3.60e+6-3.60e+6 sec | Count: 1 |
| Flexural Yield Strength | 177-420 MPa | Average value: 332 MPa Grade |
| | | Count: 42 |
| | 94.5-267 MPa | Average value: 158 MPa Grade |
| | @Temperature 100-175° C. | Count: 1 |
| Flexural Modulus | 12.5-18.6 GPa | Average value: 15.5 GPa Grade |
| | | Count: 48 |
| | 4.90-13.0 GPa | Average value: 7.76 GPa Grade |
| | @Temperature 100-175° C. | Count: 1 |
| Compressive Yield | 159-314 MPa | Average value: 213 MPa Grade |
| Strength | | Count: 7 |
| Poissons Ratio | 0.380-0.410 | Average value: 0.398 Grade |
| | | Count: 6 |
| Shear Modulus | 0.350-4.00 GPa | Average value: 1.75 GPa Grade |
| | @Temperature 0.000-350° C. | Count: 3 |
| Shear Strength | 75.8-108 MPa | Average value: 91.3 MPa Grade |
| | | Count: 8 |
| Izod Impact, Notched | 0.590-4.97 J/cm | Average value: 1.36 J/cm Grade |
| | | Count: 25 |
| | 0.690-0.690 J/cm | Average value: 0.690 J/cm Grade |
| | @Temperature 135-135° C. | Count: 1 |
| | 0.690-0.690 J/cm | Average value: 0.690 J/cm Grade |
| | @Time 3.60e+6-3.60e+6 sec | Count: 1 |
| Izod Impact, Unnotched | 3.86-13.0 J/cm | Average value: 8.66 J/cm Grade |
| | | Count: 12 |
| Izod Impact, Notched | 7.80-100 kJ/m² | Average value: 16.1 kJ/m² Grade |
| (ISO) | | Count: 20 |
| | 11.0-13.5 kJ/m² | Average value: 12.5 kJ/m² Grade |
| | @Temperature −40.0-−20.0° C. | Count: 6 |
| Izod Impact, Unnotched | 61.0-87.0 kJ/m² | Average value: 74.0 kJ/m² Grade |
| (ISO) | | Count: 5 |
| Charpy Impact Unnotched | 1.00-9.50 J/cm² | Average value: 7.60 J/cm² Grade |
| | | Count: 25 |
| | 1.40-9.00 J/cm² | Average value: 6.55 J/cm² Grade |
| | @Temperature −30.0-−30.0° C. | Count: 8 |
| Charpy Impact, Notched | 0.200-9.00 J/cm² | Average value: 1.63 J/cm² Grade |
| | | Count: 32 |
| | 1.10-7.00 J/cm² | Average value: 2.14 J/cm² Grade |
| | @Temperature −40.0-−30.0° C. | Count: 11 |
| Tensile Creep Modulus, 1 | 10000-14000 MPa | Average value: 11700 MPa Grade |
| hour | | Count: 3 |
| Tensile Creep Modulus, | 7500-12000 MPa | Average value: 9170 MPa Grade |
| 1000 hours | | Count: 3 |
| Electrical Properties | | |
| Electrical Resistivity | 1.00e+11-1.00e+17 ohm-cm | Average value: 6.20e+15 ohm-cm |
| | | Grade Count: 23 |
| Surface Resistance | 1.00e+12-2.00e+15 ohm | Average value: 6.40e+14 ohm |
| | | Grade Count: 8 |
| Dielectric Constant | 3.40-6.10 | Average value: 4.30 Grade |
| | | Count: 17 |
| Dielectric Strength | 18.9-40.0 kV/mm | Average value: 25.5 kV/mm Grade |
| | | Count: 16 |
| Dissipation Factor | 0.00400-0.0500 | Average value: 0.0154 Grade |
| | | Count: 18 |
| Arc Resistance | 125-300 sec | Average value: 190 sec Grade |
| | | Count: 6 |
| Comparative Tracking | 325-600 V | Average value: 555 V Grade |
| Index | | Count: 22 |
| Hot Wire Ignition, HWI | 120-150 sec | Average value: 140 sec Grade |
| | | Count: 3 |
| High Amp Arc Ignition, | 60.0-120 arcs | Average value: 77.7 arcs Grade |
| HAI | | Count: 3 |
| High Voltage Arc-Tracking | 4.00-18.0 mm/min | Average value: 13.2 mm/min Grade |
| Rate, HVTR | | Count: 6 |
| Thermal Properties | | |
| CTE, linear | 12.0-500 μm/m-° C. | Average value: 104 μm/m-° C. Grade |
| | | Count: 15 |
| | 8.00-500 μm/m-° C. | Average value: 161 μm/m-° C. Grade |
| | @Temperature 55.0-250° C. | Count: 9 |
| CTE, linear, Transverse to | 36.0-76.0 μm/m-° C. | Average value: 53.5 μm/m-° C. |
| Flow | | Grade Count: 12 |
| | 53.0-150 μm/m-° C. | Average value: 96.4 μm/m-° C. |
| | @Temperature 55.0-250° C. | Grade Count: 8 |
| Melting Point | 260-327° C. | Average value: 309° C. Grade |
| | | Count: 34 |
| Maximum Service | 140-210° C. | Average value: 164° C. Grade |
| Temperature, Air | | Count: 7 |
| Deflection Temperature at | 120-320° C. | Average value: 270° C. Grade |
| 0.46 MPa (66 psi) | | Count: 20 |
| Deflection Temperature at | 90.0-302° C. | Average value: 268° C. Grade |
| 1.8 MPa (264 psi) | | Count: 51 |
| Deflection Temperature at | 205-250° C. | Average value: 229° C. Grade |
| 8.0 MPa | | Count: 4 |
| Vicat Softening Point | 100-295° C. | Average value: 241° C. Grade |
| | | Count: 5 |
| Glass Transition Temp, | 135-144° C. | Average value: 141° C. Grade |
| Tg | | Count: 3 |
| Flammability, UL94 | HB-V-0 | Grade Count: 32 |
| Flame Spread | 17.0-29.0 mm/min | Average value: 25.0 mm/min Grade |
| | | Count: 4 |
| Oxygen Index | 24.0-49.0% | Average value: 31.8% Grade |
| | | Count: 4 |
| Glow Wire Test | 700-960° C. | Average value: 836° C. Grade |
| | | Count: 3 |
| Processing Properties | | |
| Processing Temperature | 79.4-340° C. | Average value: 148° C. Grade |
| | | Count: 7 |
| Nozzle Temperature | 320-338° C. | Average value: 329° C. Grade |
| | | Count: 4 |
| Melt Temperature | 270-360° C. | Average value: 322° C. Grade |
| | | Count: 51 |
| Mold Temperature | 65.6-180° C. | Average value: 127° C. Grade |
| | | Count: 48 |
| Drying Temperature | 80.0-130° C. | Average value: 110° C. Grade |
| | | Count: 45 |
| Moisture Content | 0.0300-0.200% | Average value: 0.0803% Grade |
| | | Count: 37 |
| | 0.850-0.850% | Average value: 0.850% Grade |
| | @Temperature 70.0-70.0° C. | Count: 2 |
| Dew Point | −31.7-−28.9° C. | Average value: −30.1° C. Grade |
| | | Count: 7 |
| Injection Pressure | 41.4-124 MPa | Average value: 88.2 MPa Grade |
| | | Count: 9 |

### Celanese THERMX LED 0201 PCT, 40% Specialty

| | Metric | Comments |
|---|---|---|
| Physical Properties | | |
| Density | 1.62 g/cc | ISO 1183 |
| Linear Mold Shrinkage, | 0.0030 cm/cm | ISO 294-4 |
| Flow | | |
| Linear Mold Shrinkage, | 0.0090 cm/cm | ISO 294-4 |
| Transverse | | |
| Mechanical Properties | | |
| Tensile Strength at Break | 73.0 MPa | 5 mm/min; ISO 527-2/1A |
| Elongation at Break | 1.7% | 5 mm/min; ISO 527-2/1A |
| Tensile Modulus | 6.27 GPa | 50 mm/min; ISO 527-2/1A |
| Charpy Impact | 3.20 J/cm² | ISO 179/1eU |
| Unnotched | | |
| Charpy Impact, Notched | 0.320 J/cm² | ISO 179/1eA |
| Thermal Properties | | |
| CTE, linear, Parallel to | 32.0 μm/m-° C. | ISO 11359-2 |
| Flow | | |
| CTE, linear, Transverse to | 102 μm/m-° C. | ISO 11359-2 |
| Flow | | |
| Melting Point | 285° C. | 10° C./min; ISO |
| | | 11357-1,-2,-3 |
| Processing Properties | | |
| Processing Temperature | 100-150° C. | cavity |
| Zone 1 | 290-305° C. | |
| Zone 2 | 285-300° C. | |
| Zone 3 | 285-300° C. | |
| Zone 4 | 285-300° C. | |
| Die Temperature | 285-295° C. | |
| Melt Temperature | 290-310° C. | |
| Drying Temperature | 95.0-100° C. | |
| Dry Time | 4.00-6.00 hour | |
| Moisture Content | <=0.030% | |

### DuPont Crastin FG6129 NC010 PBT

| | Metric | Comments |
|---|---|---|
| Physical Properties | | |
| Density | 1.30 g/cc | ISO 1183 |
| Melt Density | 1.12 g/cc | |
| | @Temperature 250° C. | |
| Water Absorption | 0.40% | Sim. to ISO 62 |
| | @Thickness 2.00 mm | |
| Moisture Absorption | 0.200% | Sim. to ISO 62 |
| | @Thickness 2.00 mm | |
| Viscosity Test | 150 cm³/g | Viscosity number; ISO 307, 1157, |
| | | 1628 |
| Linear Mold Shrinkage, | 0.017 cm/cm | ISO 294-4, 2577 |
| Flow | | |
| Linear Mold Shrinkage, | 0.015 cm/cm | ISO 294-4, 2577 |
| Transverse | | |
| Melt Flow | 10 g/10 min | ISO 1133 |
| | @Load 2.16 kg, | |
| | Temperature 250° C. | |
| Mechanical Properties | | |
| Tensile Strength, Yield | 58.0 MPa | ISO 527-1/-2 |
| Elongation at Break | >=50% | Nominal; ISO 527-1/-2 |
| Elongation at Yield | 5.0% | ISO 527-1/-2 |
| Tensile Modulus | 2.60 GPa | ISO 527-1/-2 |
| Flexural Strength | 85.0 MPa | ISO 178 |
| Flexural Modulus | 2.35 GPa | ISO 178 |
| Izod Impact, Notched | 4.50 kJ/m² | ISO 180/1A |
| (ISO) | @Temperature 23.0° C. | |
| | 6.00 kJ/m² | ISO 180/1A |
| | @Temperature −30.0° C. | |
| Izod Impact, Unnotched | 130 kJ/m² | ISO 180/1U |
| (ISO) | @Temperature −30.0° C. | |
| | NB | ISO 180/1U |
| | @Temperature 23.0° C. | |
| Charpy Impact | NB | ISO 179/1eU |
| Unnotched | @Temperature 23.0° C. | |
| | NB | ISO 179/1eU |
| | @Temperature −30.0° C. | |
| Charpy Impact, Notched | 0.400 J/cm² | ISO 179/1eA |
| | @Temperature −30.0° C. | |
| | 0.550 J/cm² | ISO 179/1eA |
| | @Temperature 23.0° C. | |
| Tensile Creep Modulus, 1 | 2600 MPa | ISO 899-1 |
| hour | | |
| Tensile Creep Modulus, | 1800 MPa | ISO 899-1 |
| 1000 hours | | |
| Electrical Properties | | |
| Volume Resistivity | >=1.00e+15 ohm-cm | IEC 60093 |
| Surface Resistance | 1.00e+12 ohm | IEC 60093 |
| Dielectric Strength | 26.0 kV/mm | IEC 60243-1 |
| Comparative Tracking | 600 V | IEC 60112 |
| Index | | |
| Thermal Properties | | |
| CTE, linear, Parallel to | 130 μm/m-° C. | ISO 11359-1/-2 |
| Flow | | |
| CTE, linear, Transverse to | 130 μm/m-° C. | ISO 11359-1/-2 |
| Flow | | |
| Specific Heat Capacity | 2.09 J/g-° C. | melt |
| Thermal Conductivity | 0.250 W/m-K | Melt |
| Melting Point | 225° C. | 10° C./min; ISO 11357-1/-3 |
| Deflection Temperature at | 115° C. | ISO 75-1/-2 |
| 0.46 MPa (66 psi) | | |
| | 180° C. | Annealed; ISO 75-1/-2 |
| Deflection Temperature at | 50.0° C. | ISO 75-1/-2 |
| 1.8 MPa (264 psi) | | |
| | 60.0° C. | ISO 75-1/-2 |
| Vicat Softening Point | 175° C. | 50° C./h, 50N; ISO 306 |
| Flammability, UL94 | HB | IEC 60695-11-10 |
| | @Thickness 1.50 mm | |
| | HB | IEC 60695-11-10 |
| | @Thickness 0.900 mm | |
| Oxygen Index | 22% | ISO 4589-1/-2 |
| Processing Properties | | |
| Melt Temperature | >=240° C. | |
| | 250° C. | Optimum |
| | <=260° C. | |
| Mold Temperature | >=30.0° C. | |
| | 80.0° C. | Optimum |
| | <=130° C. | |
| Ejection Temperature | 170° C. | |
| Drying Temperature | 110° C. | |
| | @Time 7200-14400 sec | |
| | 120° C. | |
| | @Time 7200-14400 sec | |
| | 130° C. | |
| | @Time 7200-14400 sec | |
| Moisture Content | 0.040% | |
| Hold Pressure | 60.0 MPa | |

### DuPont Performance Polymers Zytel® HTN54G35HSLR NC010 PA-IGF35

| | Metric | Comments |
|---|---|---|
| Physical Properties | | |
| Density | 1.42 g/cc | DAM; ISO 1183 |
| Linear Mold Shrinkage, | 0.0020 cm/cm | DAM; ISO 294-4, 2577 |
| Flow | | |
| | 0.0060 cm/cm | DAM; ISO 294-4, 2577 |
| Mechanical Properties | | |
| Tensile Strength at Break | 180 MPa | DAM; ISO 527-1/-2 |
| Elongation at Break | 3.0% | DAM; ISO 527-1/-2 |
| Tensile Modulus | 10.0 GPa | DAM; ISO 527-1/-2 |
| Flexural Modulus | 9.00 GPa | DAM; ISO 178 |
| Poissons Ratio | 0.38 | DAM; ISO 527-1/-2 |
| Charpy Impact | 7.50 J/cm² | DAM; ISO 179/1eU |
| Unnotched | @Temperature 23.0° C. | |
| Charpy Impact, Notched | 0.900 J/cm² | DAM; ISO 179/1eA |
| | @Temperature −40.0° C. | |
| | 1.10 J/cm² | 50% RH; ISO 179/1eA |
| | @Temperature 23.0° C. | |
| | 1.20 J/cm² | DAM; ISO 179/1eA |
| | @Temperature 23.0° C. | |
| Tensile Creep Modulus, 1 | 11000 MPa | 50% RH; ISO 899-1 |
| hour | | |
| Tensile Creep Modulus, | 10000 MPa | 50% RH; ISO 899-1 |
| 1000 hours | | |
| Electrical Properties | | |
| Surface Resistance | 1.00e+14 ohm | 50% RH; IEC 60093 |
| Dielectric Strength | 42.0 kV/mm | 50% RH; IEC 60243-1 |
| | 43.0 kV/mm | DAM; IEC 60243-1 |
| Comparative Tracking | 600 V | DAM; IEC 60112 |
| Index | | |
| Thermal Properties | | |
| CTE, linear, Parallel to | 20.0 μm/m-° C. | DAM; ISO 11359-1/-2 |
| Flow | | |
| | 20.0 μm/m-° C. | DAM; ISO 11359-1/-2 |
| | @Temperature −40.0-23.0° C. | |
| CTE, linear, Transverse to | 72.0 μm/m-° C. | DAM; ISO 11359-1/-2 |
| Flow | | |
| | 75.0 μm/m-° C. | DAM; ISO 11359-1/-2 |
| | @Temperature −40.0-23.0° C. | |
| Thermal Conductivity | 0.350 W/m-K | Solid |
| Melting Point | 300° C. | first heat; DAM; ISO 11357-1/-3 |
| Deflection Temperature at | 285° C. | DAM; ISO 75-1/-2 |
| 0.46 MPa (66 psi) | | |
| Deflection Temperature at | 255° C. | DAM; ISO 75-1/-2 |
| 1.8 MPa (264 psi) | | |
| Processing Properties | | |
| Melt Temperature | >=320° C. | |
| | 325° C. | Optimum |
| | <=330° C. | |
| Mold Temperature | >=85.0° C. | |
| | <=135° C. | |
| Drying Temperature | 100° C. | |
| | @Time 21600-28800 sec | |
| Moisture Content | 0.10% | |

Some of the above specified plastics are suitable for 3D printing or injection moulding as fabrication methods. Some of the parts may be generic parts that are readily obtainable (such as the motors and screws and belts) and others may be manufactured specifically for the robot arm (casing parts such as the shell parts and covers and caps; drive transmission parts such as gear parts and pulley parts; bearing parts; strengthening parts such as flanges and brackets; and mounting parts such as retainers and mounts). By providing most of the parts of the robot arm in plastic an overall weight of 2 to 6 kg can be achieved for the example described above, and typically approximately 5 kg. By providing most of the parts of the robot arm in plastic the cost of a robotic arm can be kept relatively low.

To give sufficient strength to the robotic arm where it is substantially made of plastic, internal brackets may be designed to strengthen certain portions of the arm. Ribbing may be integrated in the casing parts to increase the strength. The wall thickness may be up to 12 mm in parts that require extra strength, such as the base. Parts that require less strength (such as the tool segment) may be thinner, for example as thin as 2 mm.

The maximum payload of the robotic arm made of plastic and dimensioned as described above is in the range of 0.3 to 3 kg, and typically 1 to 2 kg or approximately 1.5 kg.

The robot arm may be mounted at the base 18 to a table, wall, ceiling or an inclined surface. At or near the base a data port is provided for connection of the robot arm to a controller such as a suitably programmed computer. The data port may for example be a USB 2.0/3.0/4.0 port, CAN port or a wireless connection port. At or near the base a power port is provided for supplying power to the motors in the robotic arm. A typical power requirement of the motors may be DC 24V 10 A; the base may include a switched-mode power supply to ensure the motors are provided with suitable power.

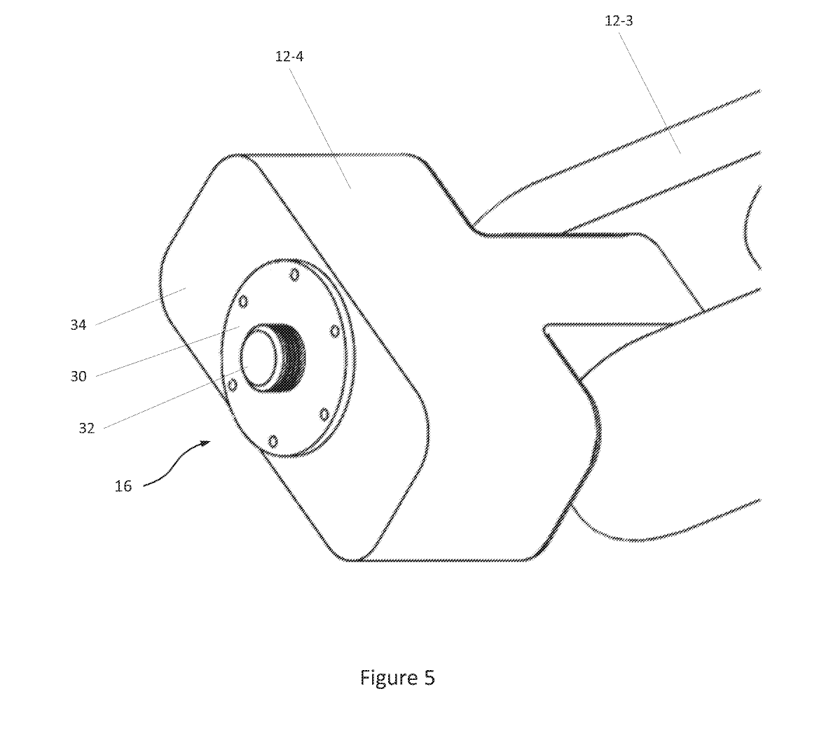

FIG. 5 shows the tool interface 16 in more detail. The tool interface 16 is presented at the end of the tool segment 12-4. The tool segment 12-4 presents a surface 34 into which the interfacing components are embedded. The surface 34 is approximately 80 mm by 40 mm. The surface 34 can help stabilise a tool attachment to the robotic arm.

The interfacing components embedded in the surface 34 include an electronically controllable tool attachment 30. The attachment 30 serves to physically affix a tool to the tool segment 12-4. In the illustrated example the attachment 30 is disc-shaped with approximately 38 mm outer diameter and embedded in the centre of the surface 34. In the illustrated example the electronically controllable tool attachment 30 can be an electromagnetic attachment where a permanent magnet presented by a tool is either attracted to the interface 16 and affixed there, or not, depending on electric actuation of the electromagnetic attachment. By enabling electronically controllable tool attachment the robot arm can be controlled to exchange tools without requiring any human assistance. This can widen the scope of tasks a robot arm can perform and hence increase its usefulness.

The interfacing components also include ports such as a data port, a power port and a pressure port. In the illustrated example a data and power port are combined in a circular male connector 32, and the tool presents a connectable female port that can be mated for connection. In the illustrated example the connector 32 for the data and power port is cylindrical with approximately 15 mm diameter and 8 mm height (and the corresponding female connector on the tool is similarly cylindrical) such that angular orientation of a tool about the connection axis does not affect the connection. This can allow attachment of a tool in an arbitrary angular orientation. This is convenient for a tool such as a screw head attachment, where a specific axial orientation of the tool is not crucial. For other tools such as a mechanical gripper the tool can include a sensor (such as a gyroscope) for sensing tool orientation; following attachment of the tool to the robotic arm the tool orientation is determined and the tool rotated by the robot arm in the connection axis to a desired angular orientation of the tool. By permitting attachment of a tool in an arbitrary angular orientation the exchange of tools by the robotic arm is facilitated and lower dependence on human assistance can be enabled.

Some examples of tools are a mechanical gripper; a pneumatic gripper; a screw head attachment; and a machine specific attachment (such as a claw designed to fit into a handle of a particular device the robotic arm is to manipulate). In order to identify a tool each tool can have an identification that can be transmitted to the robot arm and controller via a data connection. The controller can then identify the tool. The software for controlling the robot arm allows for tool identifiers (universal global unique identifiers) to enable this.

In an alternative example the electronically controllable tool attachment 30 is not an electromagnetic attachment but an interlocking attachment that is electronically controllable, for example with a disc-shaped orifice that can receive a disc-shaped protrusion of a tool and a number or electronically controllable catches that clamp the protrusion in the orifice. The electronically controllable catches may be pneumatically actuated or electrically actuated, for example.

It will be understood that the present invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

What is claimed is:

1. A robotic arm with a tool interface comprising an electronically controllable tool attachment for affixing a tool to the interface.

2. A robotic arm according to claim 1 wherein the tool interface is an integral component of the robotic arm.

3. A robotic arm according to claim 2 wherein the tool interface is provided with resources via conduits integral to the robotic arm.

4. A robotic arm according to any preceding claim wherein the electronically controllable tool attachment is an electromagnetic attachment.

5. A robotic arm according to any preceding claim wherein the electronically controllable tool attachment is an interlocking attachment.

6. A robotic arm according to any preceding claim, wherein the tool interface further comprises a data port for data communication with a tool.

7. A robotic arm according to any preceding claim, wherein the tool interface further comprises a power port for providing power to a tool.

8. A robotic arm according to any preceding claim, wherein the tool interface further comprises a pneumatic port for providing pressure to a tool.

9. A robotic arm according to any preceding claim, wherein the tool interface is rotationally symmetrical to enable attachment of a tool in a variety of angular orientations about a connection axis.

10. A robotic arm according to claim 9, wherein the tool interface is circular to enable attachment of a tool in an arbitrary angular orientation about a connection axis.

11. A tool for use with a robotic arm according to any preceding claim that is affixable to the tool interface.

12. A tool according to claim 11 wherein the tool comprises at least one of: a mechanical gripper; a pneumatic gripper; a screw head attachment; and a machine specific attachment.

13. A tool according to claim 11 or 12 wherein the tool comprises an identifier for the robotic arm to identify the tool.

14. A tool according to any of claims 11 to 13 wherein the tool comprises a sensor to identify an orientation of the tool.

15. A system comprising a robotic arm according to any of claims 1 to 10, and a plurality of tools according to any of claims 11 to 14.

16. Software for controlling a robotic arm according to any of claims 1 to 10 with a tool according to any of claims 11 to 14 affixed to the robotic arm,

17. Software for controlling a robotic arm according to any of claims 1 to 10 with a tool according to claim 13 affixed to the robotic arm, wherein the software is adapted to receive an identification of the tool.

18. Software for controlling a robotic arm according to any of claims 1 to 10 with a tool according to claim 14 affixed to the robotic arm, wherein the software is adapted to receive an orientation of the tool.

19. Software for controlling a robotic arm according to any of claims 1 to 10 with a tool according to any of claims 11 to 14 affixed to the robotic arm, wherein the software is adapted to provide feedback when a tool is engaged or disengaged.

20. Software according to claim 19, wherein the software is adapted to provide visual feedback in the form of rendering of a representation of the tool in the appropriate position and engagement with the robotic arm.

21. A method of controlling a robotic arm according to any of claims 1 to 10 with a tool according to any of claims 11 to 14 affixed to the robotic arm.

22. A computer programme product comprising software code for carrying out the method of claim 21.

23. A tool interface for a robotic arm comprising an electronically controllable tool attachment for affixing a tool to the interface.

24. A kit of parts comprising a robotic arm according to any of claims 1 to 10 and a tool according to any of claims 11 to 14.

25. A robotic arm substantially as herein described and/or as illustrated with reference to the accompanying figures.
